(19) United States
(12) Patent Application Publication
(10) Pub. No.: US 2006/0152438 A1
(43) Pub. Date: Jul. 13, 2006

(54) Electrochemical display and drive method

(76) Inventor: Masanobu Tanaka, Kanagawa (JP)

Correspondence Address: ROBERT J. DEPKE;LEWIS T. STEADMAN, TREXLER, BUSHNELL, GLANGLORGI, BLACKSTONE & MARR, 105 WEST ADAMS STREET, SUITE 3600, CHICAGO, IL, 60603-6299, US

(21) Appl. No.: 10/535,224

(22) PCT Filed: Nov. 13, 2003
(86) PCT No.: PCT/JP03/14455

§ 371 Date: Jan. 17, 2006

(30) Foreign Application Priority Data
Nov. 22, 2002 (JP) 2002-339109

(51) Int. Cl. G09G 3/16

(52) U.S. Cl. 345/48

(57) ABSTRACT

Disclosed are an electrochemical display and a drive method therefor by which it is possible to restrain deterioration of display density with time variation and to realize excellent display characteristics.

In impressing a voltage on pixel electrodes in pixels so as to display an image through deposition and dissolution of a metal, the time of impressing a write voltage on the pixel electrodes is controlled so as to perform gradation display. In this instance, the current density of the current passed through the pixels by the write voltage is set to be not more than 50 mA/cm², the time of impressing the write voltage is divided into a plurality of sub-fields, and whether the voltage is to be impressed or not is selected in each of the sub-fields, whereby the time of impressing the write voltage is controlled.

### TECHNICAL FIELD

The present invention relates to an electrochemical display and a drive method therefor, for forming an image through deposition and dissolution of a metal by impressing a voltage on pixel electrode, and particularly to an electrochemical display and a drive method therefor suited to the so-called electronic paper.

### BACKGROUND ART

In recent years, attendant on the spread of networks, documents conventionally distributed in the form of printed matter have come to be transmitted in the form of the so-called electronic documents. Further, books and magazines have also come to be provided in the form of the so-called electronic publishing in an increasing number of cases. For reading these kinds of information, reading from CRTs (cathode ray tubes) or liquid crystal displays of computers has been widely practiced.

However, it has been pointed out that, in the case of a light emission type display such as the CRT, the fatigue of the reader is severe on a human engineering ground, and the system is unsuited to long-time reading. Besides, even a backlight type display such as liquid crystal display is also unsuited to reading, because of the flickering which is intrinsic of fluorescent bulbs. Further, both systems have the problem that the reading site is limited to the sites where a computer is installed.

In recent years, reflection type liquid crystal displays not using the backlight have been put to practical use. However, the reflectance in the case of non-display (display of white color) on liquid crystal is 30 to 40%, which means a considerably lower visibility, as compared with the reflectance of printed matter on paper (the reflectance of OA papers and pocket books is 75%, and that of newspapers is 52%). In addition, the reader is liable to be tired due to the glittering from the reflector or the like, and the system is also unsuited to long-time reading.

In order to solve these problems, those called paper-like display or electronic paper have been being developed. In these systems, principally, coloring is achieved by moving colored particles through electrophoresis or by rotating dichroic particles in an electric field. In these methods, however, the gaps between the particles absorb light, with the result of a bad contrast; in addition, these systems have the problem that a writing speed (within 1 second) suited to practical use cannot be obtained unless the drive voltage is set to or above 100 V.

As an alternative to the displays of the above-mentioned display systems, electrochromic displays (ECD) for achieving coloring based on an electrochemical action are superior to the displays of the above-mentioned systems in contrast, and have already been put to practical use as, for example, light control glass and timepiece displays. It should be noted here that the light control glass and timepiece displays do not intrinsically need matrix drive and, therefore, they themselves are unsuited to the use as the electronic paper or the like display. In addition, the ECD is generally poor in black color quality, and the reflectance thereof is still at a low level.

Besides, in using an electronic paper or the like display, the display is continuedly exposed to sunlight or room light. From this point of view, the ECD put to practical use in the light control glass and timepiece displays uses an organic material for forming the black color portions, so that they are accompanied by a problem as to light resistance. In general, organic materials are poor in light resistance, and show a lowering in black color density through fading when used for a long time.

In order to solve such technical problems, an electrochromic display (ECD) using a metal ion as a color change material and an electrochemical display using the same have been proposed. In the electrochemical display, metal ions are preliminarily dissolved in a polymer electrolyte layer, the metal is deposited and dissolved by electrochemical reduction and oxidation, and the attendant color change is utilized to achieve display. Here, when for example a color former is preliminarily contained in the polymer electrolyte layer, the contrast upon color change can be enhanced.

However, in the display using the above-mentioned ECD, a use method is adopted in which rewriting of displayed contents is not frequently performed after the contents are once displayed and in which the displayed contents are maintained for a predetermined time. The electrochemical display in which the display and non-display at pixels are switched by changing the reflectance through deposition and dissolution of a metal has had the problem that the deposited metal is dissolved as time passes after the display, so that the display density varies with the lapse of time and, particularly, a variation in displayed contents or a lowering in visibility is caused in the case of performing a multiple-stage gradation display.

Accordingly, it is an object of the present invention to provide an electrochemical display and a drive method therefor by which it is possible to restrain deterioration of display density with the lapse of time and to realize excellent display characteristics.

### DISCLOSURE OF INVENTION

In order to attain the above object, according to the present invention, there is provided an electrochemical display comprising a plurality of signal lines and a plurality of scan lines disposed in a row direction and a column direction on a substrate, and pixel circuits provided at intersection portions of the signal lines and the scan lines, the pixel circuits impressing a voltage on pixel electrodes disposed in display regions of pixels so as to display an image through deposition and dissolution of a metal, characterized in that gradation display is performed by controlling the time when the pixel circuits impress on the pixel electrodes a deposition voltage for depositing the metal.

By controlling the time of impressing on the pixel electrodes the deposition voltage for depositing the metal, the amount of the metal deposited at the pixels is controlled to vary the reflectance, whereby gradation display can be achieved by the electrochemical display.

In this instance, by setting the deposition voltage impressed on the pixel electrodes to be constant and depositing the metal so that the density of a current flowing through the pixel is not more than a predetermined value, it is possible to prevent variation in display density with time due to dissolution of the deposited metal. Besides, the density of the current flowing through the pixels is desirably not more than 50 mA/cm². The control of the time of impressing a write voltage may be realized also by dividing the voltage-impressing time into a plurality of sub-fields and selecting, in each sub-field, whether the deposition voltage is to be impressed or not.

In addition, in order to attain the above object, according to the present invention, there is provided an electrochemical display comprising a plurality of signal lines and a plurality of scan lines disposed in a row direction and a column direction on a substrate, and pixel circuits provided at intersection portions of the signal lines and the scan lines, the pixel circuits impressing a voltage on pixel electrodes disposed in display regions of pixels so as to display an image through deposition and dissolution of a metal, characterized in that the deposition voltage is varied in a multiplicity of stages when the pixel circuits impress on the pixel electrodes a deposition voltage for depositing the metal.

By varying the deposition voltage for depositing the metal in a multiplicity of stages, it is possible to vary in a multiplicity of stages the amount of the metal deposited per unit time, and to vary the time for depositing a predetermined amount of the metal at the pixel.

In this case, by impressing an emphasis pulse voltage such that the density of a current flowing through the pixel is not less than a predetermined value and thereafter impressing a write voltage such that the current density is not more than a predetermined value, it is possible to shorten the time until the display at the pixels reaches a target reflectance. Besides, by varying the density of the current flowing through the pixel from a value of not less than 50 mA/cm² to a value of not more than 50 mA/cm², it is possible to effectively restrain dissolution of the deposited metal, so that the variation in the reflectance with time can be reduced and a good contrast can be maintained.

In addition, by controlling the time of impressing the deposition voltage on the pixel electrodes, the amount of the metal deposited at the pixels is controlled to vary the reflectance, whereby gradation display can be achieved by the electrochemical display.

Besides, in order to attain the above object, according to the present invention, there is provided an electrochemical display comprising a plurality of signal lines and a plurality of scan lines disposed in a row direction and a column direction on a substrate, and pixel circuits provided at intersection portions of the signal lines and the scan lines, the pixel circuits impressing a voltage on pixel electrodes disposed in display regions of pixels so as to display an image through deposition and dissolution of a metal, characterized in that the time when the pixel circuits impress on the pixel electrodes a deposition voltage for depositing the metal is divided into a plurality of sub-fields, and whether the voltage is to be impressed or not is selected in each of the sub-fields, whereby the time of impressing the deposition voltage on the pixel electrodes is controlled.

The reflectance which is the black display density at the pixel depends on the amount of the metal deposited in the pixel; therefore, by appropriately selecting and combining the plurality of sub-fields obtained by dividing the time of impressing a voltage on the pixel electrode, it is possible to control the time of impressing the deposition voltage on the pixel electrodes, and to display gradation in a multiplicity of stages.

In addition, by a system in which the plurality of sub-fields obtained by dividing the time of impressing a voltage on the pixel electrodes is so set that the sub-fields differ in the duration period and the ratios of time length of the sub-fields are about the n-th power of 2 (n is an integer), the voltage-impressing time is divided into n sub-fields, whereby gradation display in 2ⁿ stages can be achieved. This makes it possible to make constant the impressed voltage in all the sub-fields and to set a voltage-supplying data driver to be binary in the form of ON/OFF which does not need an output of multiple values, and it is thereby possible to reduce the circuit scale and to contrive a reduction in the module cost.

Besides, when a write stoppage period for stopping the deposition of the metal in all pixels is provided after the sub-fields, the amount of the metal deposited can be limited on a sub-field basis; therefore, it is possible to control the deposition amount of the metal when the sub-fields are selectively combined, and to obtain good display characteristics.

In addition, in order to attain the above object, according to the present invention, there is provided an electrochemical display comprising a plurality of signal lines and a plurality of scan lines disposed in a row direction and a column direction on a substrate, and pixel circuits provided at intersection portions of the signal lines and the scan lines, the pixel circuits impressing a voltage on pixel electrodes disposed in display regions of pixels so as to display an image through deposition and dissolution of a metal, characterized in that the pixel circuits each comprise: a selection transistor for determining the pixel at which the metal is to be deposited; a drive transistor for impressing the voltage on the pixel electrode; and a voltage holding capacitance for holding a voltage impressed on a gate electrode of the drive transistor.

Besides, in order to attain the above object, according to the present invention, there is provided an electrochemical display comprising a plurality of signal lines and a plurality of scan lines disposed in a row direction and a column direction on a substrate, and pixel circuits provided at intersection portions of the signal lines and the scan lines, the pixel circuits impressing a voltage on pixel electrodes disposed in display regions of pixels so as to display an image through deposition and dissolution of a metal, characterized in that each of the pixel circuits comprises a first transistor, a second transistor, and a capacitor, and is connected to a common wiring and a ground wiring; one of source-drain electrodes of the first transistor is connected to the signal line; a gate electrode of the first transistor is connected to the scan line; the other of the source-drain electrodes of the first transistor is connected to the gate electrode and one of electrodes of the capacitor of the second transistor; the other of the electrodes of the capacitor is connected to the earth line; one of source-drain electrodes of the second transistor is connected to the pixel electrode; and the other of the source-drain electrodes of the second transistor is connected to the common electrode.

In addition, in order to attain the above object, according to the present invention, there is provided a drive method for an electrochemical display characterized in that, at the time of displaying an image through deposition and dissolution of a metal by impressing a voltage on pixel electrodes at pixels, gradation display is performed by controlling the time when a deposition voltage for depositing the metal is impressed on the pixel electrode.

By controlling the time when the deposition voltage for depositing the metal is impressed on the pixel electrode, it is possible to control the amount of the metal deposited in the pixel, thereby to vary the reflectance, and to perform gradation display by the electrochemical display.

In this instance, by making constant the deposition voltage impressed on the pixel electrodes and depositing the metal so that the density of a current flowing through the pixel is not more than a predetermined value, it is possible to prevent the display density from being varied with time due to dissolution of the deposited metal. In addition, the density of the current flowing through the pixels is desirably not more than 50 mA/cm². The control of the time of impressing a write voltage may be realized also by dividing the voltage-impressing time into a plurality of sub-fields and selecting in each sub-field whether a deposition voltage is to be impressed or not.

Besides, in order to attain the above object, according to the present invention, there is provided a drive method for an electrochemical display characterized in that, at the time of displaying an image through deposition and dissolution of a metal by impressing a voltage on pixel electrodes in pixels, a deposition voltage impressed on the pixel electrodes for depositing the metal is varied in a multiplicity of stages.

By varying in a multiplicity of stages the deposition voltage for depositing the metal, it is possible to vary in a multiplicity of stages the amount of the metal deposited per unit time, and to vary the time for depositing a predetermined amount of the metal in the pixel.

In this case, by impressing an emphasis pulse voltage such that the density of a current flowing through the pixel is not less than a predetermined value and thereafter impressing a write voltage such that the current density is not more than a predetermined value, it is possible to shorten the time until the display at the pixel reaches a target reflectance. Besides, by varying the density of the current flowing through the pixels from a value of not less than 50 mA/cm² to a value of not more than 50 mA/cm², it is possible to effectively restrain dissolution of the deposited metal, so that the variation in reflectance with time can be reduced, and a good contrast can be maintained.

In addition, by controlling the time of impressing the deposition voltage on the pixel electrodes, it is possible to control the amount of the metal deposited in the pixel, thereby to vary the reflectance, and to perform gradation display by the electrochemical display.

Besides, in order to attain the above object, according to the present invention, there is provided a drive method for an electrochemical display characterized in that, at the time of displaying an image through deposition and dissolution of a metal by impressing a voltage on pixel electrodes in pixels, the time of impressing on the pixel electrodes a deposition voltage for depositing the metal is divided into a plurality of sub-fields, and whether a voltage is to be impressed or not is selected in each of the sub-field periods, whereby the time of impressing the deposition voltage on the pixel electrodes is controlled.

The reflectance which is the black display density at the pixel depends on the amount of the metal deposited in the pixel; therefore, by appropriately selecting and combining a plurality of the sub-fields obtained by dividing the time of impressing a voltage on the pixel electrodes, it is possible to control the time of impressing the deposition voltage on the pixel electrodes, and display gradation in a multiplicity of stages.

In addition, when the plurality of the sub-fields obtained by dividing the time of impressing the voltage on the pixel electrodes are so set that the sub-fields differ in duration period and the ratios of time lengths of the sub-fields are about the n-th power of 2 (n is an integer), the voltage-impressing time can be divided into n sub-fields, whereby gradation display in 2ⁿ stages can be achieved. This makes it possible to make constant the impressed voltage in all the sub-fields, to set a voltage-supplying data driver to be binary in the form of ON/OFF which does not need multiple values, to reduce the circuit scale, and to contrive a reduction in the module cost.

Besides, when a write stoppage period for stopping the metal deposition in all the pixels is provided after the sub-fields, the amount of the metal deposited can be limited on a sub-field basis, so that the amount of the metal deposited when the sub-fields are selectively combined can be controlled, and good display characteristics can be obtained.

### BRIEF DESCRIPTION OF DRAWINGS

FIG. 1 schematically shows the structure of an electro-deposition display.

FIG. 2 is a circuit diagram showing one example of a pixel circuit 6 for driving a pixel in the electro-deposition display.

FIG. 3 is a characteristic diagram showing a current-voltage transient response characteristic in the case where a triangular wave voltage is impressed between a column electrode and a row electrode.

FIG. 4 is an operation sequence at the time of writing for forming an image in the electro-deposition display.

FIG. 5 is a graph of optical response characteristics showing the time variation of reflectance in the case where a voltage is impressed on a polymer electrolyte layer.

FIG. 6 is a graph showing the time variation of the density of a current flowing when a voltage is impressed on the polymer electrolyte layer.

FIG. 7 is a graph of optical response characteristics showing reflectance obtained in the case where −1.5 V is impressed on the polymer electrolyte layer and the voltage-impressing time is varied.

FIG. 8 is a graph of optical response characteristics showing the time variation of reflectance after a voltage is impressed on the polymer electrolyte layer.

FIG. 9 is a graph showing optical response characteristics in the case where −1.2 V is impressed on the polymer electrolyte layer.

FIG. 10 is a graph showing the time variation of reflectance in the case where display density is controlled by deposition period.

FIG. 11 is a graph showing optical response characteristics when an emphasis pulse impressing period of 0.05 sec is provided in the beginning of the deposition period and a write voltage impressing period of 0.25 sec is provided after the same.

FIG. 12 is a graph showing the time variation of reflectance in a memory period after the deposition period while the settings of the emphasis pulse impressing period and the write voltage impressing period are changed.

FIG. 13 is a schematic diagram showing the concept of the weighing of sub-fields used in a drive method for the electro-deposition display.

### BEST MODE FOR CARRYING OUT THE INVENTION

### First Embodiment

Now, a first embodiment of an electrochemical display and a drive method for the electrochemical display according to the present invention will be described in detail below referring to the drawings. Incidentally, the present invention is not limited to the following description, and appropriate modifications are possible without departure from the gist of the invention.

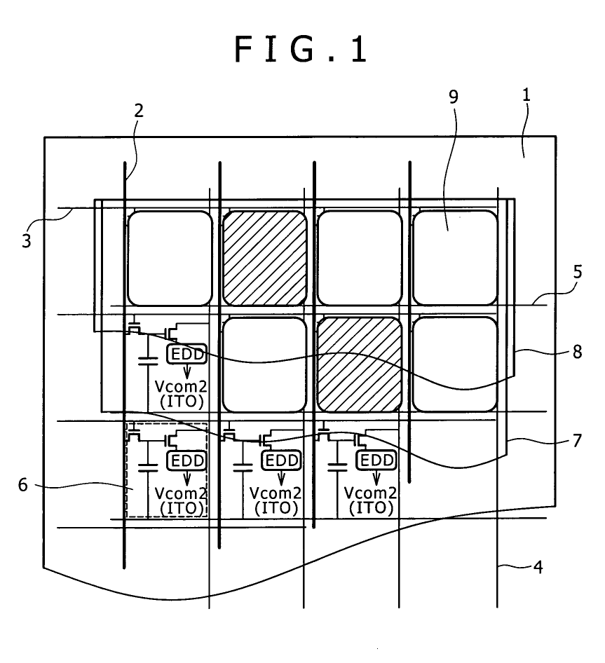

The display in this embodiment is an electro-deposition display (EDD) for displaying an image through deposition and dissolution of a metal by utilizing electro-deposition characteristics, and is driven by an active matrix drive method. FIG. 1 schematically shows the structure of the electro-deposition display according to the present invention, in which data lines 2, gate scan lines 3, a common wiring 4 and a GND wiring 5 are provided on a back substrate 1, and pixel circuits 6 are formed at intersection portions of electrodes. The data lines 2 and the gate scan lines 3 are disposed in a row direction and a column direction orthogonally to each other, and pixel electrodes 9 connected to the pixel circuits 6 are provided at the intersection portions of the data lines 2 and the gate scan lines 3, to form pixels. The data lines 2, the gate scan lines 3, the common wiring 4 and the GND wiring 5 are electrode groups for driving the pixel circuits 6 by different potentials, and are isolated from each other by insulation films (not shown) for prevent mutual contact thereof.

A polymer electrolyte layer 7 is laminated on the electrode groups and the pixel electrodes 9. A transparent electrode 8 is laminated on the polymer electrolyte layer 7. Therefore, the polymer electrolyte layer 7 is sandwiched between the pixel electrodes 9 formed on the back substrate 1 and the transparent electrode 8, and a voltage impressed on the transparent electrode 8 and the pixel electrodes 9 causes deposition and dissolution of a metal in the polymer electrolyte layer 7, thereby performing image display.

Examples of a matrix polymer used for the polymer electrolyte layer 7 include polyethylene oxide, polyethyleneimine, and polyethylene sulfide, whose skeleton units are respectively represented by the formulas —(C—C—O)ₙ—, —(C—C—N)ₙ—, and —(C—C—S)ₙ—. With these as main chain structures, branching may be present. In addition, polymethyl methacrylate, polyvinylidene fluoride, polyvinylidene chloride, polycarbonates and the like are also preferable as the matrix polymer.

In forming the polymer electrolyte layer 7, it is preferable to add a required plasticizer to the matrix polymer. Preferable plasticizers in the case where the matrix polymer is hydrophilic include water, ethyl alcohol, isopropyl alcohol, and mixtures thereof, whereas preferable plasticizers in the case where the matrix polymer is hydrophobic include propylene carbonate, dimethyl carbonate, ethylene carbonate, γ-butyrolactone, acetonitrile, sulfolane, dimethoxyethane, ethyl alcohol, isopropyl alcohol, dimethylformamide, dimethyl sulfoxide, dimethylacetamide, n-methylpyrrolidone, and mixtures thereof.

The polymer electrolyte layer 7 is formed by dissolving an electrolyte in the matrix polymer. Examples of the electrolyte include not only metallic salts capable of functioning as a color former for display but also quaternary ammonium halides (F, Cl, Br, I), alkali metal halides (LiCl, LiBr, LiI, NaCl, NaBr, NaI, etc.), alkali metal cyanides, and alkali metal thiocyanides. A material containing at least one support electrolyte selected from these examples is dissolved as an electrolyte.

Here, examples of the metallic ion constituting the metallic salt functioning as the color forming material include ions of bismuth, copper, silver, lithium, iron, chromium, nickel, and cadmium, which are used either singly or in combination. Arbitrary salts of these metals may be used as the metallic salt. For example, the silver salts include silver nitrate, silver borofluoride, silver halides, silver perchlorate, silver cyanide, and silver thiocyanide.

Besides, the polymer electrolyte layer 7 may include a coloring material added thereto for enhancing contrast. Where the coloring by deposition of a metal is black, it is preferable that the background color is white, and a material high in hiding power of white color is preferably introduced as the coloring material. Examples of such a material include white particles for coloring, and examples of the white particles for coloring include titanium dioxide, calcium carbonate, silica, magnesium oxide, and aluminum oxide.

In the case of inorganic particles, the ratio in which the white pigment is mixed is preferably about 1 to 20 wt %, more preferably about 1 to 10 wt %, and further preferably about 5 to 10 wt %. The limitation to such a range is because of the following. The white pigments such as titanium oxide are not dissolved into the polymer but are merely dispersed into the polymer, and, when the ratio in which the white pigment is mixed increases, the white pigment would be coagulated, with the result of a nonuniform optical density. Besides, since the white pigments lacks ionic conductivity, an increase in the mixing ratio leads to a lowering in the conductivity of the polymer electrolyte. In consideration of both the points, the upper limit of the mixing ratio is about 20 wt %.

Where the inorganic particles are mixed as a coloring material into the polymer electrolyte layer 7, the thickness of the polymer electrolyte layer 7 is preferably 10 to 200 μm, more preferably 10 to 100 μm, and further preferably 10 to 50 μm. As the polymer electrolyte layer 7 is thinner, the resistance between the electrodes is lower, which is preferable since it leads to shortening of the color forming and decoloring times and to a reduction in power consumption. However, when the thickness of the polymer electrolyte layer 7 is reduced to below 10 μm, mechanical strength is lowered, with the result of inconveniences such as generation of pinholes or cracks. On the other hand, when the thickness of the polymer electrolyte layer 7 is too small, the amount of the inorganic particles mixed is reduced, whereby the whiteness (optical density) might become insufficient.

Incidentally, where a coloring matter is used as the coloring material to be mixed into the polymer electrolyte layer 7, the ratio in which the coloring material is mixed may be not more than 10 wt %. This is because the color forming efficiency of the coloring matter is much higher than that of inorganic particles. Therefore, in the case of a coloring matter which is electrochemically stable, a sufficient contrast can be obtained even if the amount of the coloring matter is small. Preferable examples of the coloring matter include oil-soluble dyes.

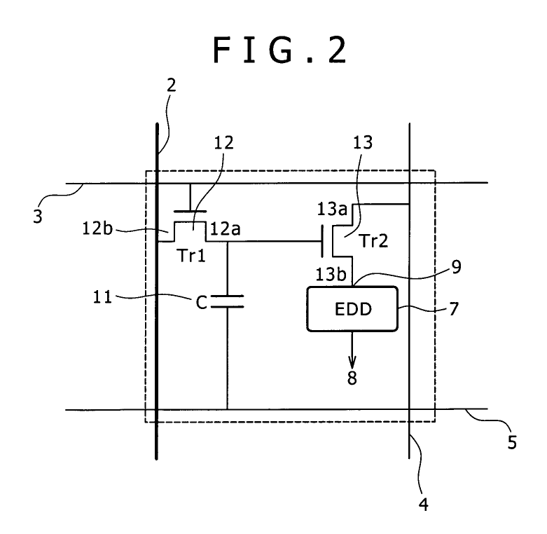

One example of the pixel circuit 6 for driving the pixel in the electro-deposition display is shown in FIG. 2. The data lines 2 and the common wiring 4 are disposed in parallel to each other with the longitudinal directions thereof set in the vertical direction in the drawing, whereas the gate scan lines 3 and the GND wiring 5 are disposed in parallel to each other with the longitudinal directions thereof set in the left-right direction in the drawing. In addition, the pixel circuit 6 has a capacitor 11, a first transistor 12, and a second transistor 13.

The data lines 2 function as signal lines for supplying a data potential for driving the pixel circuit 6. The gate scan line 3 functions as a scan line for selecting the pixel circuit 6 to be driven, by scanning in line sequence the pixel circuits 6 formed on the back substrate 1. The common wiring 4 and the GND wiring (ground wiring) 5 determine a voltage impressed on the polymer electrolyte layer 7 by the potential difference therebetween.

One of electrodes of the capacitor 11 is connected to the GND wiring 5, while the other of the electrodes is connected to the source-drain electrode 12a of the first transistor 12 and the gate electrode of the second transistor 13. The gate electrode of the first transistor 12 is connected to the gate scan line 3, the source-drain electrode 12b of the first transistor 12 is connected to the data line 2, and the source-drain electrode 12a of the first transistor 12 is connected to the gate electrode of the second transistor 13 and the capacitor 11. The source-drain electrode 13a of the second transistor 13 is connected to the common wiring 4, the source-drain electrode 13b of the second transistor 13 is connected to the pixel electrode 9, and the source-drain electrode 12a of the first transistor 12 and one of the electrodes of the capacitor 11 are connected to the gate electrode of the second transistor 13.

The first transistor 12 functions as a selection transistor for determining the pixel for deposition of the metal, while the second transistor 13 functions as a drive transistor for impressing a voltage on the pixel electrode, and the capacitor 11 functions as a voltage holding capacitance for holding the voltage impressed on the gate electrode of the second transistor 13. The pixel electrode 9 is in contact with the polymer electrolyte layer 7 superposed on the pixel circuit 6, and, in pair with a transparent electrode 8 opposed thereto, impresses a voltage on the polymer electrolyte layer 7.

While the electro-deposition display utilizing electro-deposition characteristics is configured as above-described, a drive method for the display will be described below.

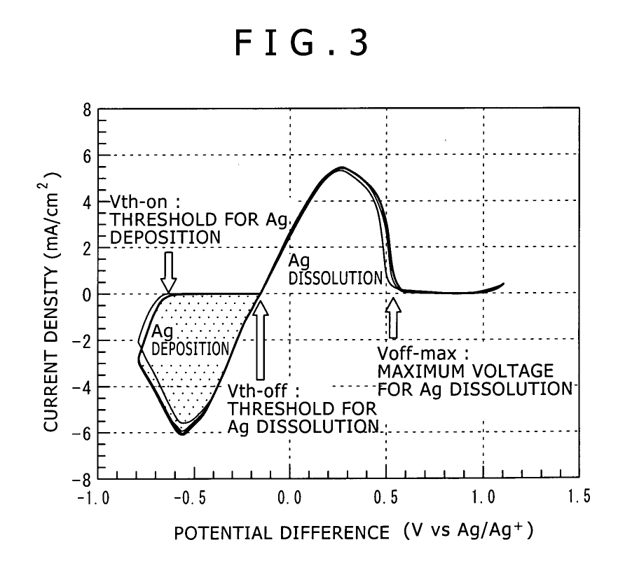

In the display utilizing the electro-deposition characteristics, where a triangular wave voltage is impressed between the transparent electrode 8 and the pixel electrode 9, a current-voltage transient response characteristic as shown in FIG. 3 is displayed. When a voltage is gradually impressed between the transparent electrode 8 and the pixel electrode 9 from zero to the minus side, deposition of silver does not occur for a while, and the deposition of silver on the transparent electrode 8 starts when the voltage exceeds a deposition threshold voltage Vₜₕ₋ₒₙ.

The deposition of silver continues even when the voltage is lowered after exceeding a write voltage corresponding to the apex of the triangular wave voltage, and the deposition continues even after the voltage is lowered below the above-mentioned deposition threshold voltage Vₜₕ₋ₒₙ. The deposition of silver is finished when the impressed voltage is lowered to a dissolution threshold voltage V_{th-off}. On the other hand, when a voltage in the opposite polarity (plus) is impressed between the transparent electrode 8 and the pixel electrode 9, dissolution of silver begins, and silver disappears when the voltage reaches a dissolution maximum voltage V_{off-max}.

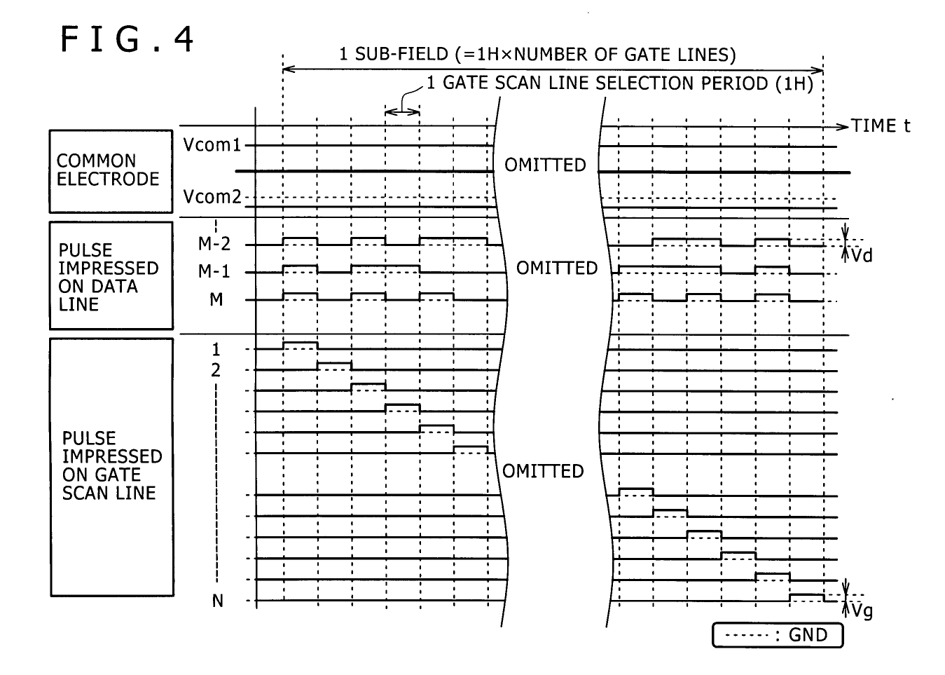

An operation sequence at the time of writing for forming an image in the above-described electro-deposition display is shown in FIG. 4. FIG. 4 shows the sequence in one sub-field period which is the time required for line sequential scanning of the gate scan lines 3 on the entire part of a screen, with respect to the potentials impressed on the data lines 2, the gate scan lines 3, the common wiring 4, and the transparent electrode 8. The voltage impressed on the common wiring 4 is denoted by Vcom1, whereas the voltage impressed on the transparent electrode 8 is denoted by Vcom2. On the entire part of the screen, N gate scan lines 3 are formed, and M data lines 2 are formed. Where a ate scan line selection period for which the voltage is impressed on one gate scan line 3 is denoted by 1H, the time required for one sub-field is represented by the formula 1H×N.

The potential of the common wiring 4 connected to the source-drain electrode 13a of the second transistor 13, denoted by Vcom1, is kept at a ground potential over the entire part of the sub-field period. A minus potential Vcom2 lower than the deposition threshold voltage Vₜₕ₋ₒₙ shown in FIG. 3 is impressed on the transparent electrode 8 as a deposition voltage for depositing the metal on the polymer electrolyte layer 7, over the entire part of the sub-field period.

A gate selection voltage Vg is impressed on the gate scan lines 3, from the first line to the N-th line, in a gate scan line selection period, whereby scanning is conducted in a line sequential mode. During the period in which the gate selection voltage Vg is not impressed on the gate scan lines 3, a ground potential is impressed on the gate scan lines 3. Synchronously with the gate selection voltage Vg impressed on the gate scan lines 3, a data voltage Vd is impressed on the data line 2 corresponding to the pixel in which the metal is deposited. During the period in which the data voltage Vg is not impressed on the data lines 2, the ground potential is impressed on the data lines 2. In this instance, the gate selection voltage Vg is not less than a voltage required for turning ON the first transistor 12, and the data voltage Vd is not less than a voltage necessary for turning ON the second transistor 13.

When the gate selection voltage Vg is impressed in the line sequential mode, a voltage is impressed on the gate electrode of the first transistor 12 in the pixel circuit 6 shown in FIG. 2 to put the first transistor 12 into the ON state, in the pixels connected to the gate scan line 3 on which the gate selection voltage Vg is being impressed. In each of the pixels where the metal deposition is not conducted, the gate electrode of the second transistor 13 is at the ground potential because the data line 2 is at the ground potential, and no current flows between the source-drain electrode 13a and the source-drain electrode 13b of the second transistor 13, so that no current flows through the polymer electrolyte layer 7. In addition, since both terminals of the capacitor 11 are at the ground potential, the amount of electric charge accumulated in the capacitor 11 is zero.

However, in each of the pixels where the metal deposition is conducted, since the data voltage Vd is impressed on the data line 2, the second transistor 13 is put into the ON state, and a current flows between the source-drain electrode 13a and the source-drain electrode 13b of the second transistor 13, so that the deposition voltage Vcom2 for depositing the metal is impressed on the polymer electrolyte layer 7 sandwiched between the transparent electrode 8 and the pixel electrode 9, and a current flows through the polymer electrolyte layer 7. In addition, an electric charge is accumulated in the capacitor 11 according to the data voltage Vd. Therefore, even where the impression of the gate selection voltage Vg on the gate scan line 3 is stopped and the first transistor 12 is in the OFF state, the electric charge accumulated in the capacitor 11 keeps the data voltage Vd on the gate electrode of the second transistor 13, and the ON state of the second transistor 13 is maintained, so that a current continues flowing through the polymer electrolyte layer 7.

The condition where the second transistor 13 is ON due to the electric charge accumulated in the capacitor 11 continues until the gate selection voltage Vg is impressed on the gate scan line 3 and, simultaneously, the data line 2 is brought to the ground voltage in the next and latter sub-fields. In this case, the first transistor 12 is put into the ON state because the gate selection voltage Vg is impressed on the gate scan line 3, the electric charge having been accumulated in the capacitor 11 is brought to zero because the data line 2 is at the ground potential, the gate electrode of the second transistor 13 is also brought to the ground potential, and the second transistor 13 is put into the OFF state. Therefore, no current flows between the source-drain electrode 13a and the source-drain electrode 13b of the second transistor 13, no current flows through the polymer electrolyte layer 7, and metal deposition is stopped.

In the electro-deposition display according to the present invention as above-described, when a current flows through the polymer electrolyte layer 7 in the pixel selected in a sub-field period and metal deposition is conducted, the metal deposition continues until the ground potential is given to the data line 2 simultaneously with the gate selection voltage Vg impressed on the gate scan line 3 of the relevant pixel, in the next and latter field periods. This makes it possible to regulate the time when the metal is deposited at a position, corresponding to the pixel, of the polymer electrolyte layer 7.

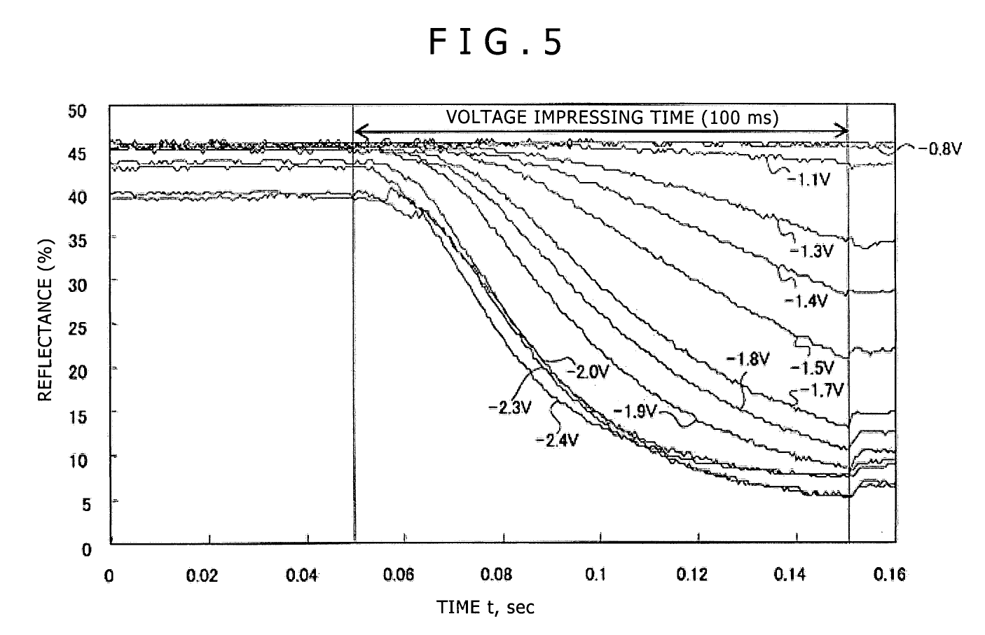

In the next place, referring to FIGS. 5 to 10, in connection with the voltage of a current passed through the polymer electrolyte layer 7 for metal deposition and optical response characteristics, the reason why gradation display in the electro-deposition display can be realized by controlling the time when a current at a predetermined value flows through the polymer electrolyte layer 7 and the reason why the display contents can be maintained by controlling the time variation of reflectance through reducing the density of the current flowing through the polymer electrolyte layer 7 will be described below.

FIG. 5 is a graph of optical response characteristics showing the time variation of reflectance in the case where a voltage is impressed on the polymer electrolyte layer 7. The axis of abscissa indicates the lapse of time in seconds, and the period in which the voltage is impressed is from 0.05 sec to 0.15 sec. The axis of ordinates indicates the reflectance as the ratio in which the light incident on the pixel is reflected, and a lower reflectance value indicates a denser black display.

When a voltage of −2.4 to −0.8 V was impressed, a tendency toward a lower reflectance with the lapse of time was observed over the entire voltage range. The reflectance at time t=0.15 sec when the impression of the voltage was stopped corresponded to impressed voltages of −0.8 V, −1.1 V, −1.3 V, −1.4 V, −1.5 V, −1.7 V, −1.8 V, −1.9 V, −2.4 V, −2.3 V, and −2.0 V, in the order of decreasing reflectance. This shows that the lowering in the reflectance is kept small where the potential difference is small and that the lowering in the reflectance is conspicuous where the potential difference is large. This can be understood to be because metal deposition is continuedly performed with the lapse of time and, where the potential difference is large, the current flowing is large and, therefore, the amount of the metal deposited is large.

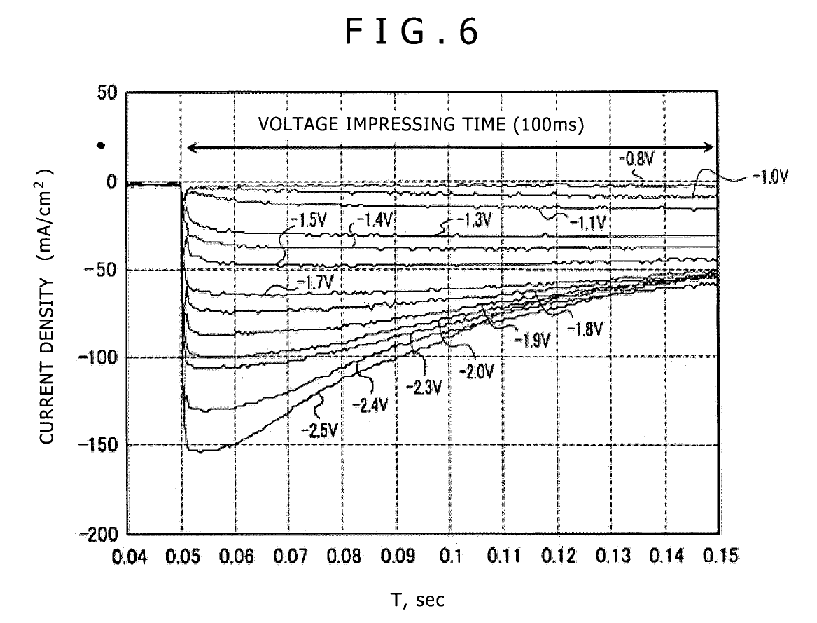

Next, a graph of the time variation of the density of the current flowing when a voltage is impressed on the polymer electrolyte layer 7 is shown in FIG. 6. The axis of abscissas indicates the lapse of time in seconds, and the period in which the voltage is impressed is from 0.05 sec to 0.15 sec. The axis of ordinates indicates the current density of the current flowing through the polymer electrolyte layer 7 in mA/cm².

The graph in FIG. 6 shows the time variation of the current density when a voltage of −2.5 to −0.8 V was impressed, and indicates the impressed voltages of −0.8 V, −1.1 V, −1.3 V, −1.4 V, −1.5 V, −1.7 V, −1.8 V, −1.9 V, −2.0 V, −2.3 V, −2.4 V, and −2.5 V, in the order of increasing current density from the smallest current density at time t=0.06 sec. It is seen that the current density during the voltage impressing period can be regarded as constant at a potential difference of not more than −1.5 V at which the current density is not more than −50 mA/cm², but, at a potential difference is more than −1.5 V at which the current density is more than −50 mA/cm², the current density is large in the beginning period of voltage impression but is lowered with the lapse of time.

It is seen from FIG. 5 that, at a potential difference of not more than −1.5 V at which the current density can be regarded as constant, the time variation of reflectance is roughly linear. This can be considered as follows. Since the density of the current flowing through the polymer electrolyte layer 7 is roughly constant, the amount of the metal deposited is also roughly constant, and the reflectance is also varied in a constant ratio. Therefore, by setting the voltage impressed on the polymer electrolyte layer 7 at a fixed value of not more than 1.5 V and varying the time when the voltage is impressed, gradation display can be performed by varying the reflectance of the pixels.

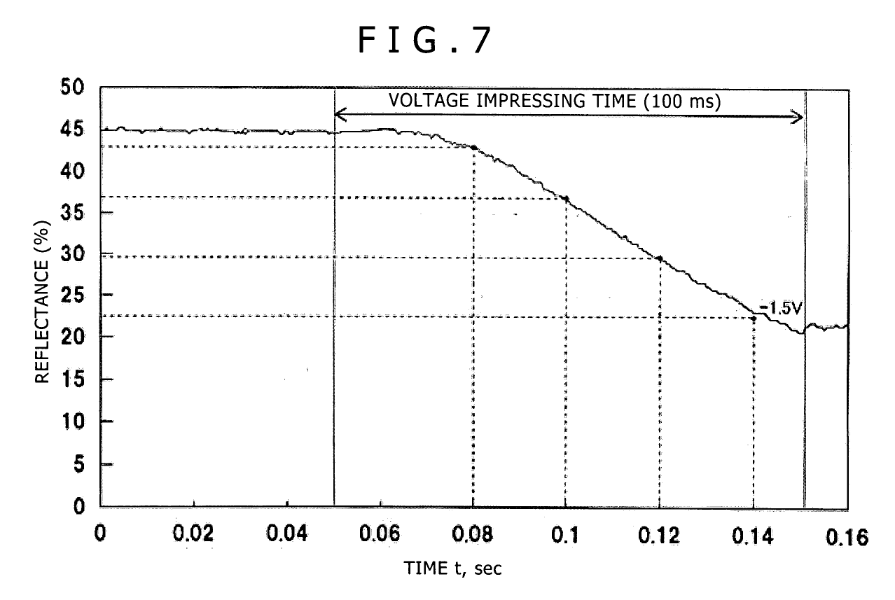

FIG. 7 is a graph showing the reflectance obtained when −1.5 V was impressed on the polymer electrolyte layer 7 as a deposition voltage and the time of impressing the deposition voltage was varied. The reflectance when the voltage impressing time was 0.08 sec was about 44%, the reflectance corresponding to a voltage impressing time of 0.10 sec was about 38%, the reflectance corresponding to a voltage impressing time of 0.12 sec was about 30%, and the reflectance corresponding to a voltage impressing time of 0.14 sec was about 23%. Therefore, it is seen that, by controlling the time of impressing the deposition voltage on a pixel basis, it is possible to realize gradation display for displaying the reflectance differing on a pixel basis.

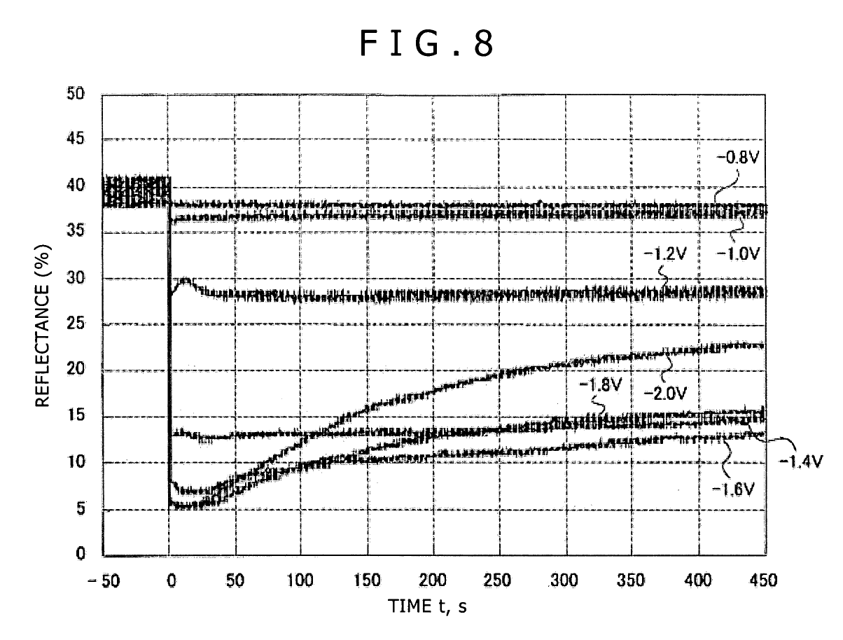

In the electro-deposition display according to the present invention, a use method in which the display contents are maintained for a certain period of time as an electronic paper is assumed, so that a memory period for holding the display contents is required after completion of the deposition of the metal in the entire part of the screen. Therefore, the display characteristics after the metal deposition in each pixel by impressing the deposition voltage on the polymer electrolyte layer 7 are important. A graph of optical response characteristics representing the time variation of reflectance after impressing the voltage on the polymer electrolyte layer 7 is shown in FIG. 8. The axis of abscissas indicates the lapse of time in seconds, and the deposition period in which the deposition voltage is impressed is from 0.05 sec to 0.15 sec. The axis of ordinates indicate the reflectance as the ratio in which the light incident on the pixel is reflected. In order to know the time variation of reflectance in the case where a memory period is set long, as compared with the period in which metal deposition is conducted, time t to 450 sec is shown. Though not shown in the graph, a write stoppage period in which the ground potential is impressed on the data lines 2 of all the pixels and the second transistor 13 is in the OFF state is provided between the deposition period and the memory period.

The curves in the graph indicate the cases of impressing voltages of −0.8 V, −1.0 V, −1.2 V, −1.4 V, −1.6 V, −1.8 V, and −2.0 V in the order of decreasing reflectance from a high reflectance in the beginning stage of the memory period. It is seen that the reflectance is roughly constant over the memory period in the case where a potential difference of −0.8 to −1.4 V is impressed, but, where a potential difference greater than −1.6 V is impressed, the reflectance is varied and the black display density is lowered, with the lapse of time. The variation in the display density of the pixel during the memory period means a variation in the contrast on the display screen; therefore, impression of such a voltage leading to the time variation of reflectance is unfavorable on a display characteristic basis.

From the point that the display density is lowered with the lapse of time, it is seen that the metal deposited in the deposition period is dissolved in the polymer electrolyte layer 7. In addition, since the variation in reflectance is greater as the impressed deposition voltage is greater, it is seen that the amount of the metal dissolved during the memory period is larger as the density of the current flowing during the deposition period is greater. From these it is presumed that when the deposition voltage impressed in the deposition period is high, the density of the current flowing through the polymer electrolyte layer 7 is great, so that the amount of the metal deposited per unit time is large; however, since the metal is deposited in a porous form, the ratio of surface area to volume is large, and dissolution of the metal in the condition where the impressing of the voltage is stopped is liable to occur.

The above-mentioned reasons are considered as reasons why the time variation of reflectance is generated when the deposition voltage impressed on the polymer electrolyte layer 7 is high, and, therefore, it is desired that the density of the current flowing through the polymer electrolyte layer 7 is not more than a predetermined value. In the graph shown in FIG. 8, variation in reflectance could not observed at −1.4 V, but some change in reflectance was observed at −1.6 V. Referring to the graph in FIG. 6, it is seen that the level of −50 mA/cm² of the current density constitutes a boundary line. Therefore, it is desired that the density of the current flowing through the polymer electrolyte layer 7 in the deposition period for metal deposition is not more than −0.5 mA/cm².

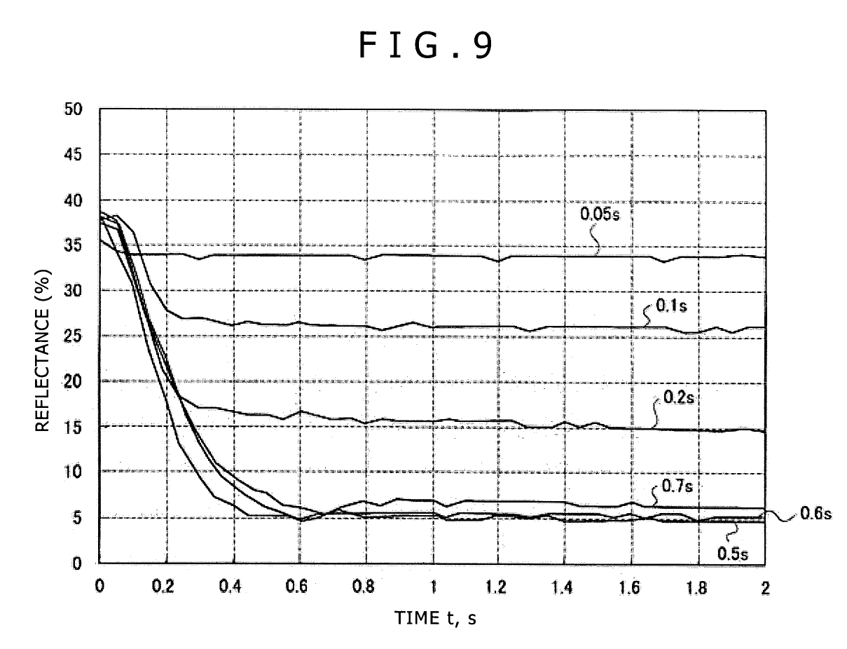

Based on the above-mentioned findings, an experiment in which a low voltage is impressed on the polymer electrolyte layer 7 to cause metal deposition at a current density of not more than −50 mA/cm² and to perform screen display was conducted. FIG. 9 is a graph showing optical response characteristics in the case where −1.2 V was impressed on the polymer electrolyte layer 7 as a deposition voltage. The axis of abscissas indicates the lapse of time in seconds, and the axis of ordinates indicates the ratio in which the light incident on the image is reflected. The graph shows optical response characteristics when the density of the current flowing through the polymer electrolyte layer 7 at the time of impressing a voltage is roughly constant at about −30 mA/cm² and the deposition period for which the deposition voltage is impressed is varied from 0.05 sec to 0.70 sec.

The graph shows curves corresponding to deposition periods of 0.05 sec, 0.1 sec, 0.2 sec, 0.5 sec, 0.6 sec, and 0.7 sec, in the order of decreasing reflectance at time t=0.4 sec and later in the graph. It is seen that the reflectance is small and dense black display occurs, in deposition periods of up to 0.5 sec. It is seen that, though a large difference is not generated in the reflectance finally reached in deposition periods of 0.5 sec or more, the display density of the electro-deposition display can be controlled by controlling the deposition period.

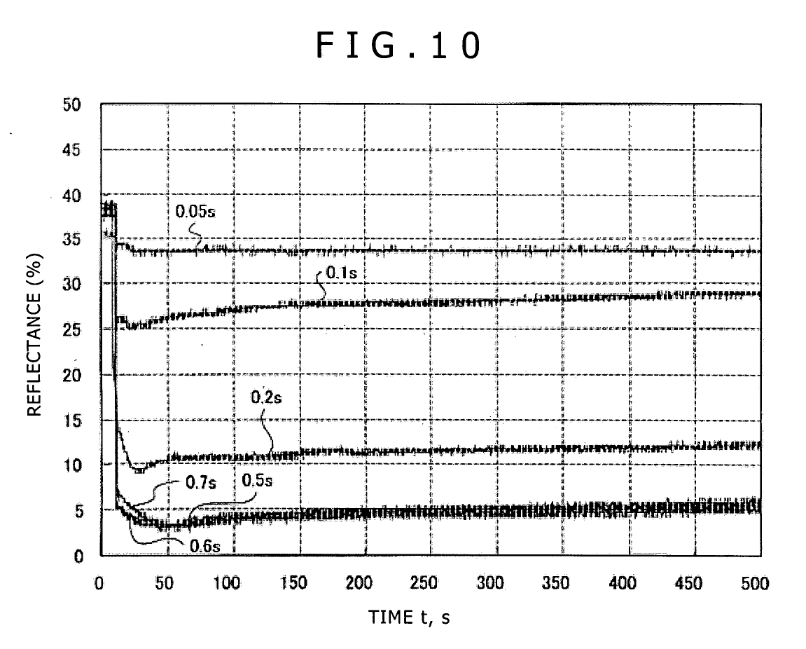

FIG. 10 is a graph showing the time variation in reflectance in the case where the display density is controlled by the deposition period, in which the memory period after the deposition period under the conditions shown in FIG. 9 is shown up to 500 sec. The graph shows the cases of the deposition periods of 0.05 sec, 0.1 sec, 0.2 sec, 0.5 sec, 0.6 sec, and 0.7 sec, in the order of decreasing reflectance, and shows that variation in reflectance is small even with the lapse of time. This is considered as follows. Since the density of the current flowing through the polymer electrolyte layer 7 is not more than −50 mA/cm², the metal is deposited not in porous form but uniformly, and the metal is not liable to be dissolved during the memory period.

Therefore, by reducing the density of the current flowing through the polymer electrolyte layer 7 during the deposition period and controlling the deposition period to control the metal deposited, gradation display can be achieved by controlling the display density in the electro-deposition display. In addition, by setting the density of the current flowing through the polymer electrolyte layer 7 during the deposition period at a value of not more than −50 mA/cm², it is possible to restrain the metal from being dissolved during the memory period, to reduce the time variation in reflectance, and to realize maintaining of a good display condition.

When metal deposition in a selected pixel is conducted in a certain sub-field period while using the pixel circuit 6 shown in FIG. 2 and a drive sequence based on the sub-fields described referring to FIG. 4, the metal deposition is continued until the ground potential is given to the data line 2 of the relevant pixel, in the next and latter sub-field periods. Therefore, by setting the number of sub-fields for metal deposition, it is possible to regulate the deposition period for depositing the metal on a pixel basis in the polymer electrolyte layer 7, to control the reflectance under constant-voltage conditions, and to display the pixels differing in black density in the entire part of the screen of the electro-deposition display, thereby achieving gradation display.

In this instance, by setting the density of the current flowing through the polymer electrolyte layer 7 to a value of not more than −50 mA/cm², it is possible to control the time variation of reflectance in the memory period after the deposition period, to maintain a good contrast during gradation display in which the reflectance differs on a pixel basis, and to obtain good display characteristics.

### Second Embodiment

Now, a second embodiment of an electro-deposition display and a drive method for the electro-deposition display according to the present invention will be described in detail below referring to the drawings. The configuration of the electro-deposition display in this embodiment is the same as described referring to FIGS. 1 to 3 in the first embodiment above and, therefore, the description thereof will be omitted. The drive method for the electro-deposition display described in this embodiment is characterized in that a deposition voltage to be impressed on a polymer electrolyte layer for depositing a metal is divided into an emphasis pulse voltage for passing a large current and a write voltage for passing a small current, thereby impressing the voltages in a multiplicity of stages and varying the density of the current flowing through the polymer electrolyte layer during a deposition period.

The operation sequence at the time of writing for forming an image in this embodiment uses a sub-field drive equivalent to that in the first embodiment described referring to FIGS. 1 to 4 above. Therefore, when a current flows through the polymer electrolyte layer 7 of selected pixels to deposit the metal in a certain sub-field period, metal deposition is continued until a ground potential is given to data lines 2 synchronously with a gate selection voltage Vg impressed on gate scan lines 3 of the relevant pixels during the next and latter sub-field periods. This makes it possible to regulate the time of depositing the metal at positions, corresponding to the pixels, of the polymer electrolyte layer 7.

In this embodiment, in addition to the control of the deposition period by the above-mentioned sub-fields, the deposition period is divided into an emphasis pulse impressing period and a write voltage impressing period, and an emphasis pulse voltage V_{wr1} impressed on the polymer electrolyte layer 7 in the emphasis pulse impressing period is set to be higher than a write voltage V_{wr2} impressed on the polymer emphasis layer 7 in the write voltage impressing period. Namely, the deposition voltage to be impressed on the polymer electrolyte layer for metal deposition is divided into the emphasis pulse voltage V_{wr1} for passing a large current and the write voltage V_{wr2} for passing a small current, thereby impressing the voltages in a multiplicity of stages. Here, the current density of the current flowing when the emphasis pulse voltage V_{wr1} is impressed on the polymer electrolyte layer 7 may be more than −50 mA/cm², but the current density of the current flowing when V_{wr2} is impressed on the polymer electrolyte layer 7 is not more than −50 mA/cm².

The impressing of the voltages in a multiplicity of stages on the polymer electrolyte layer 7 as above is realized by a method in which the potential Vcom2 to be impressed on a transparent electrode 8 is made to be V_{wr1} during the sub-field period corresponding to the emphasis pulse impressing period and to be V_{wr2} during the sub-field period corresponding to the write voltage impressing period.

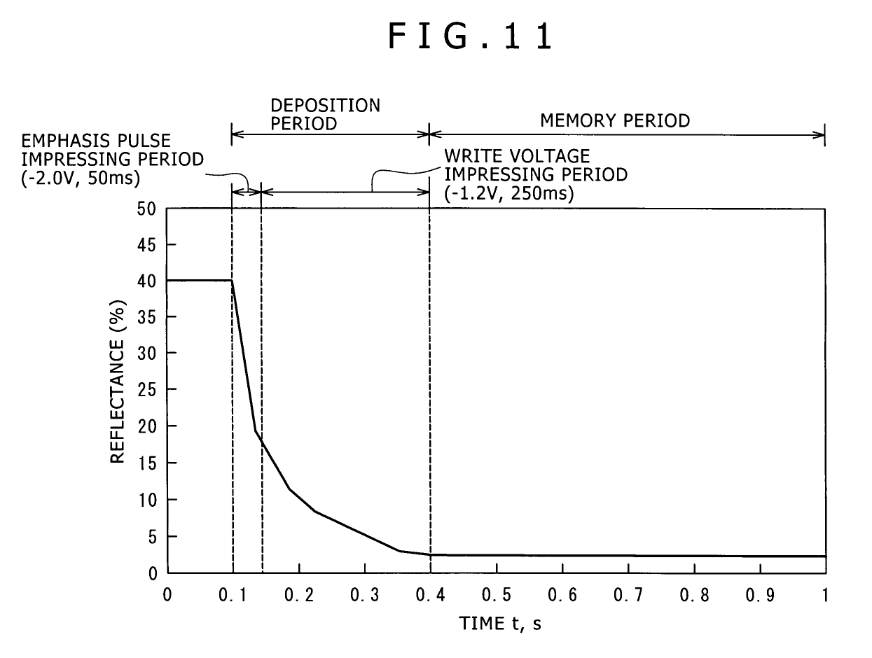

FIG. 11 is a graph showing optical response characteristics in the case where an emphasis pulse impressing period of 0.05 sec is provided in the beginning of the deposition period, and a write voltage impressing period of 0.25 sec is provided thereafter. The voltage V_{wr1} impressed during the emphasis pulse impressing period was −2.0 V, the current density of the current flowing through the polymer electrolyte layer 7 was about −100 mA/cm², the voltage V_{wr2} impressed during the write voltage impressing period was −1.2 V, and the current density was about −30 mA/cm².

It is seen that, during the emphasis pulse impressing period, the current density of the current flowing through the polymer electrolyte layer 7 is large, so that the amount of the metal deposited is large, and reflectance is lowered rapidly, whereas during the write voltage impressing period, the current density is small, so that the amount of the metal deposited is reduced, and the reflectance is lowered slowly. Therefore, by impressing V_{wr1} to pass a current with a large current density during the emphasis pulse impressing period, it is possible to deposit most of a target amount of the metal during the emphasis pulse impressing period, thereby realizing a display with a target reflectance in a shorter time, as compared with the case of impressing V_{wr2} over the entire region of the deposition period.

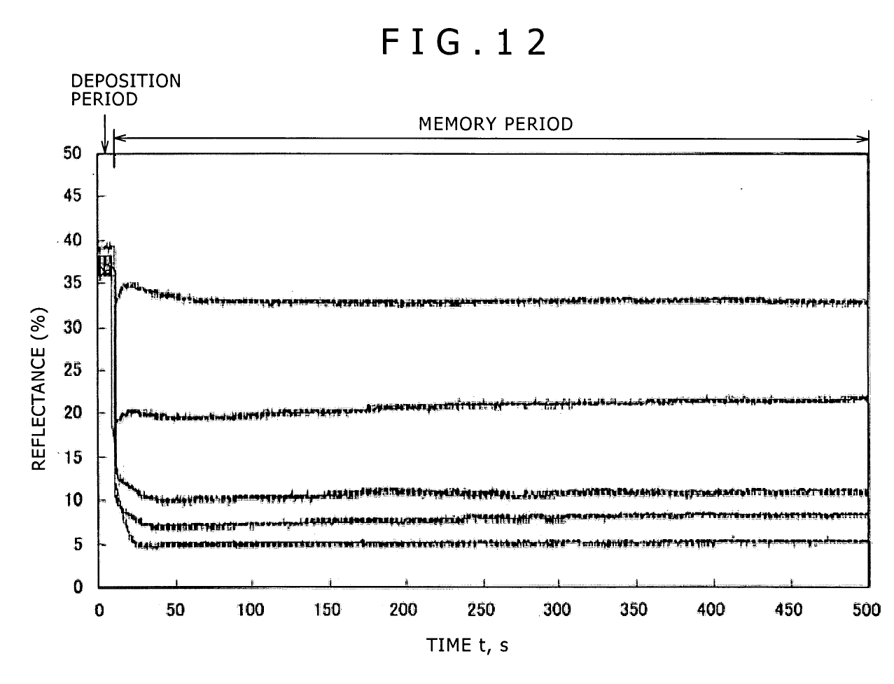

The time variation in the reflectance after the deposition period in the case where the deposition period is divided into the emphasis pulse impressing period and the write voltage impressing period, and the emphasis pulse voltage V_{wr1} impressed on the polymer electrolyte layer 7 during the emphasis pulse impressing period is set to be higher than the write voltage V_{wr2} impressed on the polymer electrolyte layer 7 during the write voltage impressing period so as to contrive a shortening of the deposition period, as above-mentioned, is shown in FIG. 12.

FIG. 12 is a graph showing the time variation of reflectance in a memory period after the deposition period in the case where the settings of the emphasis pulse impressing period and the write voltage impressing period are changed so that the reflectance values immediately after the deposition period are different. The axis of abscissas indicates the lapse of time in seconds, and the axis of ordinates indicates the reflectance as the ratio in which the light incident on the pixel is reflected. It is seen that there is little time variation of reflectance throughout the memory period and a roughly constant reflectance is maintained. In the same manner as in the first embodiment, a write stoppage period in which the ground potential is impressed on the data lines 2 in all pixels and the second transistors 13 are put into the OFF state is provided between the deposition period and the memory period.

This is considered as follows. The current density of the current flowing through the polymer electrolyte layer 7 during the emphasis pulse impressing period is greater than −50 mA/cm², and the metal being deposited is in a porous form, whereas the current density of the current flowing during the write voltage impressing period is not more than −50 mA/cm², so that the metal is deposited uniformly on the metal deposited in the porous form, whereby dissolution of the metal during the memory period is permitted with difficulty.

Therefore, the potential Vcom2 impressed on the transparent electrode 8 in the operation sequence of the electro-deposition display is made to be high in the sub-field period corresponding to the emphasis pulse impressing period and to be low in the sub-field period corresponding to the write voltage impressing period, so as to vary the potential Vcom2 in a multiplicity of stages, whereby the current density of the current flowing through the polymer electrolyte layer 7 during the deposition period for depositing the metal can be varied in a multiplicity of stages, and it is possible to shorten the deposition period and to enhance the operation speed.

In addition, by setting the number of sub-fields for depositing the metal, it is possible to regulate the deposition period for metal deposition on the basis of each pixel in the polymer electrolyte layer 7, to control the reflectance under constant-voltage conditions, and to display pixels with different black densities in the entire part of the screen of the electro-deposition display, thereby achieving gradation display.

Further, by setting the current density of the current flowing through the polymer electrolyte layer 7 during the write voltage impressing period to be not more than −50 mA/cm², it is possible to restrain the time variation of reflectance during the memory period after the deposition period, to maintain the contrast in the gradation display in which different reflectances are displayed on the basis of each pixel, and to obtain good display characteristics.

### Third Embodiment

Now, a third embodiment of an electro-deposition display and a drive method for the electro-deposition display according to the present invention will be described in detail below referring to the drawings. The configuration of the electro-deposition display in this embodiment is the same as that described referring to FIGS. 1 to 3 in the first embodiment above and, therefore, the description thereof will be omitted. The drive method for the electro-deposition display described in this embodiment is characterized in that, in the operation sequence for forming an image, the deposition period is determined by setting the duration periods of sub-fields to be different when the deposition period is controlled by superposing a plurality of sub-fields.

The operation sequence at the time of writing for forming an image in this embodiment uses the same sub-field drive as that in the first embodiment described referring to FIGS. 1 to 4 above. Therefore, when a current flows through the polymer electrolyte layer 7 of selected pixels to deposit the metal during a certain sub-field period, the metal deposition continues until the ground potential is given to the data lines 2 synchronously with a gate selection voltage Vg impressed on the gate scan lines 3 of the relevant pixels during the next and latter sub-field periods. This makes it possible to regulate the time of depositing the metal at positions, corresponding to the pixels, of the polymer electrolyte layer 7.

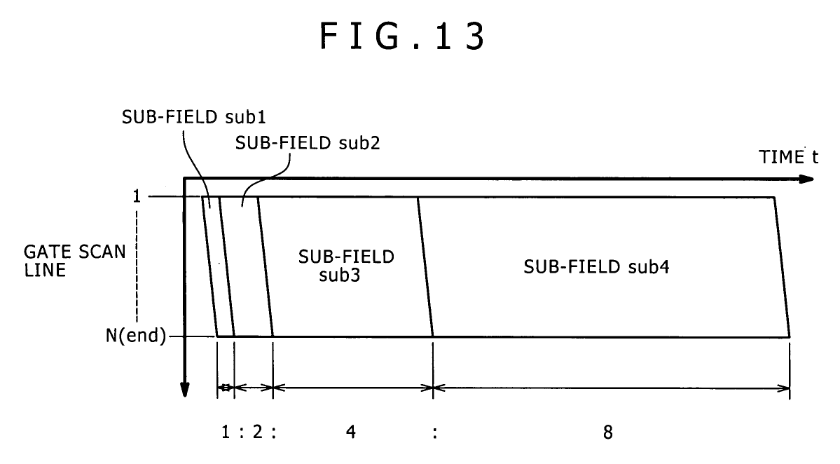

FIG. 13 is a schematic diagram showing the distribution of the duration periods of sub-fields using the drive method for the electro-deposition display in this embodiment. In the figure, the direction of the axis of abscissas indicates the lapse of time, while the direction of the axis of ordinates indicates the first to N-th gate scan lines 3, and sub-fields sub1 to sub4 represented by parallelograms in the figure are those obtained by the operation sequence of sub-fields shown in FIG. 4, respectively. Besides, the ratio of the lengths of the duration period Tsub1 of the sub-field sub1, the duration period Tsub2 of the sub-field sub2, the duration period Tsub3 of the sub-field sub3, and the duration period Tsub4 of the sub-field sub4 is Tsub1:Tsub2:Tsub3:Tsub4=1:2:4:8.

A write stoppage period in which the ground potential is impressed on the data lines 2 of all pixels and the second transistors 13 are put into the OFF state is provided between the sub-fields. Therefore, in the pixel where the metal has been deposited in each sub-field, the deposition of the metal is stopped during the write stoppage period, so that metal deposition does not occur until the relevant pixel is again selected in the latter sub-field and metal deposition is started.

The ratio of the duration periods Tsub1 to Tsub4 of the sub-fields sub1 to sub4 is realized by a method in which, referring to FIG. 4, 1H as the gate scan line selection period in which a pulse voltage is impressed on one gate scan line 3 is set to a ratio of 1:2:4:8 on the basis of the sub-fields sub1 to sub4. Or, alternatively, the ratio of the duration periods Tsub1 to Tsub4 of the sub-fields sub1 to sub4 can be controlled by a method in which 1H as the gate scan line selection period in all the sub-fields is made to be the same time, the time until the write stoppage period is controlled, whereby metal deposition in the pixels is continued, and the times of metal deposition is set to a ratio of 1:2:4:8 on a sub-field basis.

The deposition voltage impressed on the polymer electrolyte layer 7 between the sub-fields, i.e., the voltage Vcom2 impressed on the transparent electrode 8, is set at a voltage such that the current density of the current flowing through the polymer electrolyte layer 7 is not more than −50 mA/cm². With the current density set to be not more than −50 mA/cm², the amount of the metal deposited in each sub-field and dissolved after the write stoppage period is reduced, and the amount of the metal deposited in the pixels depends on the sum total of the currents passed through the pixels, as indicated by Formula 1.

$$Q = \vert {\int }_{0}^{t} i ( t ) ⅆ t \vert \qquad ( Formula 1 )$$

Therefore, the amount of the metal deposited in the pixels is equal to the sum of the amounts of the metal deposited in the sub-fields. The time ratio of the sub-fields is 2ⁿ (n is an integer), i.e., 1:2:4:8, whereby the amount of the metal deposited is represented by a binary number, in the combination of the sub-fields sub1 to sub4. For example, when metal deposition is conducted only during the sub-field sub1 and the sub-field sub4 in a certain pixel, the amount of the metal deposited in the pixel is five times the amount of the metal deposited in the sub-field sub1.

Since the reflectance, which is the black display density in a pixel, depends on the amount of the metal deposited in the pixel, by an appropriate combination of the combinations of the sub-fields for metal deposition on the basis of each pixel, a gradation display in a multiplicity of stages can be realized.

Referring to FIG. 9, there is no variation in the reflectance finally reached even when the deposition period exceeds 0.5 sec, and, therefore, Tsub1 =0.033 sec, Tsub2=0.066 sec, Tsub3=0.132 sec, and Tsub4=0.264 sec are set so that the sum the duration periods of the sub-fields sub1 to sub4 is 0.5 sec. With the periods of the sub-fields set as above and by a combination of the sub-fields for metal deposition, it is possible to realize a 16-gradation black display.

A multiple-stage gradation display can be performed by the method in which the deposition period for depositing the metal in the polymer electrolyte layer 7 is divided into a plurality of sub-fields, the time ratio of the sub-fields is set to 2ⁿ (n is an integer), i.e., 1:2:4:8, and the sub-fields are selected in combination. In addition, since the data voltage Vd impressed on the transparent electrode 8 (Vcom2) in all sub-fields is constant, the data driver for supplying the data voltage can be put into a binary mode of ON/OFF which does not need a multi-valued output, and it is possible to reduce the circuit scale and to contrive a reduction in module cost.

### INDUSTRIAL APPLICABILITY

By controlling the time of impressing on pixel electrodes the deposition voltage for depositing a metal, it is possible to control the amounts of the metal deposited in the pixels, thereby to vary the reflectance, and to perform gradation display in the electro-deposition display. In this instance, by making constant the deposition voltage impressed on the pixel electrodes and causing metal deposition so that the density of the current flowing through the pixels is not more than a predetermined value, it is possible to prevent the deposited metal from being dissolved to lead to variation in the display density with time. In addition, the density of the current flowing through the pixels is desirably not more than 50 mA/cm². The control of the time of impressing the write voltage can be realized also by dividing the voltage-impressing time into a plurality of sub-fields and selecting in each of the sub-fields whether the deposition voltage is to be impressed or not.

By varying in a multiplicity of stages the deposition voltage for depositing the metal, the amount of the metal deposited per unit time can be varied, and the time for depositing a predetermined amount of the metal in the pixel can be varied. In this case, when an emphasis pulse voltage such that the density of the current flowing through the pixel is not less than a predetermined value is impressed and, thereafter, a write voltage such that the current density is not more than a predetermined value is impressed, it is possible to shorten the time until the display at the pixel reaches a target reflectance. Besides, when the density of the current flowing through the pixel is varied from a value of not less than 50 mA/cm² to a value of not more than 50 mA/cm², it is possible to effectively restrain the deposited metal from being dissolved, to reduce the variation in reflectance with time, and to maintain a good contrast.

In addition, by a method in which a plurality of sub-fields obtained by dividing the time of impressing a voltage on pixel electrodes is so set that the duration periods of the sub-fields are different and that the ratio of the time lengths of the sub-fields is set to be about the n-th power of 2 (n is an integer), thereby dividing the voltage-impressing time into n sub-fields, it is possible to perform a 2ⁿ-stage gradation display. This makes it possible to make constant the voltage impressed on all the sub-fields, to set a voltage-supplying data driver into a binary mode of ON/OFF which does not need a multi-valued output, to reduce the circuit scale, and to contrive a reduction in module cost. In addition, by providing a write stoppage period for stopping metal deposition in all pixels after the sub-fields, it is possible to limit the amount of the metal deposited on the basis of each sub-field, to control the amount of the metal deposited when the sub-fields are selectively combined, and to obtain good display characteristics.

1. An electrochemical display comprising a plurality of signal lines and a plurality of scan lines disposed in a row direction and a column direction on a substrate, and pixel circuits provided at intersection portions of said signal lines and said scan lines, said pixel circuits impressing a voltage on pixel electrodes disposed in display regions of pixels so as to display an image through deposition and dissolution of a metal, wherein
gradation display is performed by controlling the time when said pixel circuits impress on said pixel electrodes a deposition voltage for depositing said metal.

2. The electrochemical display as set forth in claim 1, wherein said deposition voltage is constant for said pixels.

3. The electrochemical display as set forth in claim 1, wherein the density of a current caused to flow through said pixel by said deposition voltage is not more than a predetermined value.

4. The electrochemical display as set forth in claim 1, wherein the density of a current caused to flow through said pixel by said deposition voltage is not more than 50 mA/cm².

5. The electrochemical display as set forth in claim 1, wherein said control of said time of impressing said deposition voltage is performed by dividing said voltage-impressing time into a plurality of sub-fields, and whether said deposition voltage is to be impressed or not is selected in each of said sub-fields.

6. An electrochemical display comprising a plurality of signal lines and a plurality of scan lines disposed in a row direction and a column direction on a substrate, and pixel circuits provided at intersection portions of said signal lines and said scan lines, said pixel circuits impressing a voltage on pixel electrodes disposed in display regions of pixels so as to display an image through deposition and dissolution of a metal, wherein
said deposition voltage is varied in a multiplicity of stages when said pixel circuits impress on said pixel electrodes a deposition voltage for depositing said metal.

7. The electrochemical display as set forth in claim 6, wherein the time of impressing said deposition voltage on said pixel electrodes is controlled.

8. The electrochemical display as set forth in claim 6, wherein said multiple-stage variation of said deposition voltage is performed by the steps of:
impressing an emphasis pulse voltage such that the density of a current flowing through said pixel is not less than a predetermined value; and
impressing a write voltage such that the density of a current flowing through said pixel is not more than a predetermined value.

9. The electrochemical display as set forth in claim 6, wherein said multiple-stage variation of said deposition voltage impressed on said pixel electrodes is performed by the steps of:
impressing an emphasis pulse voltage such that the density of a current flowing through said pixel is not less than 50 mA/cm²; and
impressing a write voltage such that the density of a current flowing through said pixel is not more than 50 mA/cm².

10. An electrochemical display comprising a plurality of signal lines and a plurality of scan lines disposed in a row direction and a column direction on a substrate, and pixel circuits provided at intersection portions of said signal lines and said scan lines, said pixel circuits impressing a voltage on pixel electrodes disposed in display regions of pixels so as to display an image through deposition and dissolution of a metal, wherein
the time when said pixel circuits impress on said pixel electrodes a deposition voltage for depositing said metal is divided into a plurality of sub-fields, and whether said voltage is to be impressed or not is selected in each of said sub-fields, whereby the time of impressing said deposition voltage on said pixel electrodes is controlled.

11. The electrochemical display as set forth in claim 10, wherein the duration periods of said sub-fields are different from each other.

12. The electrochemical display as set forth in claim 10, wherein said duration periods of said sub-fields are so determined that the ratios among the periods of said sub-fields are the n-th power of 2 (n is an integer).

13. The electrochemical display as set forth in claim 10, wherein a write stoppage period for which said deposition of said metal is stopped at all said pixels is provided after said sub-fields.

14. An electrochemical display comprising a plurality of signal lines and a plurality of scan lines disposed in a row direction and a column direction on a substrate, and pixel circuits provided at intersection portions of said signal lines and said scan lines, said pixel circuits impressing a voltage on pixel electrodes disposed in display regions of pixels so as to display an image through deposition and dissolution of a metal, wherein
said pixel circuits each comprise:
a selection transistor for determining the pixel at which said metal is to be deposited;
a drive transistor for impressing said voltage on said pixel electrode; and
a voltage holding capacitance for holding a voltage impressed on a gate electrode of said drive transistor.

15. An electrochemical display comprising a plurality of signal lines and a plurality of scan lines disposed in a row direction and a column direction on a substrate, and pixel circuits provided at intersection portions of said signal lines and said scan lines, said pixel circuits impressing a voltage on pixel electrodes disposed in display regions of pixels so as to display an image through deposition and dissolution of a metal, wherein
each said pixel circuit comprises a first transistor, a second transistor, and a capacitor, and is connected to a common wiring and a ground wiring;
one of source-drain electrodes of said first transistor is connected to said signal line;
a gate electrode of said first transistor is connected to said scan line;
the other of said source-drain electrodes of said first transistor is connected to said gate electrode and one of electrodes of said capacitor of said second transistor;
the other of said electrodes of said capacitor is connected to said earth line;
one of source-drain electrodes of said second transistor is connected to said pixel electrode; and
the other of said source-drain electrodes of said second transistor is connected to said common electrode.

16. A drive method for an electrochemical display wherein
at the time of displaying an image through deposition and dissolution of a metal by impressing a voltage on pixel electrodes at pixels,
gradation display is performed by controlling the time when a deposition voltage for depositing said metal is impressed on said pixel electrode.

17. The drive method for an electrochemical display as set forth in claim 16, wherein said deposition voltage is constant for said pixels.

18. The drive method for an electrochemical display as set forth in claim 16, wherein the density of a current caused to flow through said pixel by said deposition voltage is not more than a predetermined value.

19. The drive method for an electrochemical display as set forth in claim 16, wherein the density of a current caused to flow through said pixel by said deposition voltage is not more than 50 mA/cm².

20. The drive method for an electrochemical display as set forth in claim 16, wherein said control of the time of impressing said deposition voltage is performed by dividing said voltage-impressing time into a plurality of sub-fields, and selecting in each said sub-field whether said deposition voltage is to be impressed or not.

21. A drive method for an electrochemical display wherein
at the time of displaying an image through deposition and dissolution of a metal by impressing a voltage on pixel electrodes in pixels,
a deposition voltage impressed on said pixel electrodes for depositing said metal is varied in a multiplicity of stages.

22. The drive method for an electrochemical display as set forth in claim 21, wherein the time of impressing said deposition voltage is controlled.

23. The drive method for an electrochemical display as set forth in claim 21, wherein said multiple-stage variation of said deposition voltage is performed by the steps of:
impressing an emphasis pulse voltage such that the density of a current flowing through said pixel is not less than a predetermined value; and
impressing a write voltage such that the density of a current flowing through said pixel is not more than a predetermined value.

24. The drive method for an electrochemical display as set forth in claim 21, wherein said multiple-stage variation of said deposition voltage is performed by the steps of:
impressing an emphasis pulse voltage such that the density of a current flowing through said pixel is not less than 50 mA/cm²; and
impressing a write voltage such that the density of a current flowing through said pixel is not more than 50 mA/cm².

25. A drive method for an electrochemical display wherein
at the time of displaying an image through deposition and dissolution of a metal by impressing a voltage on pixel electrodes in pixels,
the time of impressing on said pixel electrodes a deposition voltage for depositing said metal is divided into a plurality of sub-fields, and whether a voltage is to be impressed or not is selected in each of the sub-field periods, whereby the time of impressing said deposition voltage on said pixel electrodes is controlled.

26. The drive method for an electrochemical display as set forth in claim 25, wherein the duration periods of said sub-fields are different from each other.

27. The drive method for an electrochemical display as set forth in claim 25, wherein the duration periods of said sub-fields are so determined that the ratios among the periods of said sub-fields are the n-th power of 2 (n is an integer).

28. The drive method for an electrochemical display as set forth in claim 25, wherein a write stoppage period for stopping said deposition of said metal at all said pixels is provided after said sub-fields.
